(19) United States
(12) Patent Application Publication
(10) Pub. No.: US 2006/0059556 A1
(43) Pub. Date: Mar. 16, 2006

(54) System for managing inactivity in concurrently operating executable applications

(76) Inventor: Barry Lynn Royer, Blue Bell, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/223,305

(22) Filed: Sep. 9, 2005

Related U.S. Application Data
(60) Provisional application No. 60/609,159, filed on Sep. 10, 2004.

(51) Int. Cl. G06F 12/14

(52) U.S. Cl. 726/22

(57) ABSTRACT

A system, for use with a first application concurrently operating together with a second application, includes an activity manager and a communication processor. The activity manager intermittently receives data identifying activity associated with the first application, and determines that the first application is inactive in response to a first application timeout window being exceeded because of insufficient activity associated with the first application. The communication processor communicates to a managing application an indication that the first application is inactive, and receives from the managing application an indication that the second application is inactive determined in response to a second application timeout window being exceeded because of insufficient activity associated with the second application.

### CROSS-REFERENCE TO RELATED APPLICATIONS

The present application is a non-provisional application of provisional application having Ser. No. 60/609,159 filed by Barry Royer on Sep. 10, 2004.

### FIELD OF THE INVENTION

The present invention generally relates to computer information systems. More particularly, the present invention relates to a system for managing inactivity in concurrently operating executable applications.

### BACKGROUND OF THE INVENTION

Health Level 7 (HL7) is an international standard for data exchange between computer systems in healthcare. It provides interoperability between electronic Patient Administration Systems (PAS), Electronic Practice Management (EPM) systems, Laboratory Information Systems (LIS), Dietary, Pharmacy and Billing systems as well as Electronic Medical Record (EMR) or Electronic Health Record (EHR) systems.

Clinical Context Object Workgroup (CCOW) is a standards committee within the HL7 group that developed a CCOW part of the HL7 standard. The CCOW part of the HL7 standard is vendor independent and allows clinical applications to share information at the point of care. Using a technique called “context management,” CCOW provides a user with a unified view on the information held in separate and disparate healthcare applications referring to the same patient, encounter or user. This means that when a user signs on to one application within the group of disparate applications tied together by the CCOW environment, that same sign-on is simultaneously executed on other applications within the group. Similarly, when the user selects a patient, the same patient is selected in the other applications. CCOW builds a combined view of the patient on one display screen. CCOW works for both client-server and web-based applications.

The HL7 CCOW standard provides for a set of standard interfaces and data to be used to facilitate the coordination of common context data between multiple concurrently operating software applications. A context manager application serves as the controlling application that manages and stores the common context data. Applications participating in a common context may read and update data from the common context through a set of interfaces provided by the context manager application. The participating applications may also receive events from the context manager by supporting the CCOW participant set of interfaces. The context manager can call the methods of the participants' interfaces in order to survey the application s before finalizing a context change and again to notify them that a change has been finalized.

CCOW supports a common context logoff mechanism, which can be used to automatically log a user off the participant applications after a predetermined amount of time has passed without the user interacting with the application. For example, applications may be designated to set the common context user subject to null (i.e., logic zero as opposed to a logic one) when their inactivity timeout threshold is reached. The user subject is a logic flag, identifier, or indicator representing activity of a user in the CCOW standard, and may be otherwise called a user activity indicator. Therefore, user inactivity in one application in a session, involving multiple concurrently operating applications, may automatically trigger a log-off of the whole session, even though one or more of the other applications in that session remain actively employed by the user. Accordingly, there is a need for a system for managing inactivity in concurrently operating applications that overcomes these and other disadvantages of the prior systems.

### SUMMARY OF THE INVENTION

A system, for use with a first application concurrently operating together with a second application, includes an activity manager and a communication processor. The activity manager intermittently receives data identifying activity associated with the first application, and determines that the first application is inactive in response to a first application timeout window being exceeded because of insufficient activity associated with the first application. The communication processor communicates to a managing application an indication that the first application is inactive, and receives from the managing application an indication that the second application is inactive determined in response to a second application timeout window being exceeded because of insufficient activity associated with the second application.

### BRIEF DESCRIPTION OF THE DRAWINGS

FIG. 1 illustrates a system, in accordance with invention principles.

FIG. 2 illustrates a process flow diagram, for the system, as shown in FIG. 1, showing a first application changing to an inactive state while a second application is in an active state, in accordance with invention principles.

FIG. 3 illustrates a process flow diagram, for the system, as shown in FIG. 1, showing a first application changing to an inactive state while a second application is already in an inactive state, in accordance with invention principles.

### DETAILED DESCRIPTION OF THE PREFERRED EMBODIMENTS

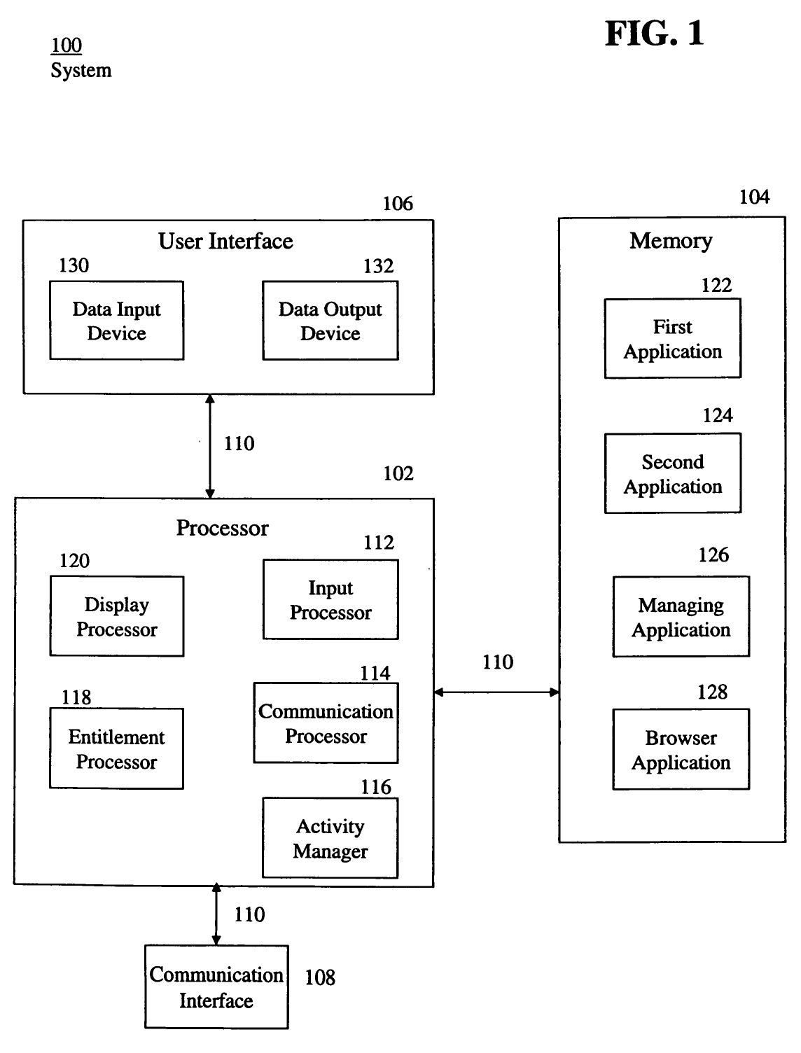

FIG. 1 illustrates a system for managing inactivity in concurrently operating applications 100 (“system”). The system 100 overcomes the disadvantages of the prior systems by managing multiple applications concurrently operating within a single common context instance by efficiently synchronizing a log-off process for an inactive user. The system 100 coordinates inactivity timeout thresholds among the multiple applications so that a user remains logged on the multiple applications, even though one of the multiple applications has reached its inactivity timeout threshold. The system 100 arbitrates between the multiple applications to ensure that the applications have reached their inactivity limit before a user is automatically logged off.

In particular, the system 100 provides a context manager to coordinate participating applications in a given common context so that a user remains logged on the participating applications, as long as at least one of the participating applications has not reached its inactivity time limit. Therefore, user inactivity in one application in a session, involving multiple concurrently operating applications, does not automatically trigger a log-off of the whole session, as long as one or more of the other participating applications remain actively employed by the user. The system 100 performs this function, without any additional software components while providing high performance and scalability. In one example, the system 100 is used with software applications that adhere to the Health Level 7 (HL7) Common Context Object Workgroup (CCOW) standard. In other examples, the system 100 may be used with any environment that runs concurrent executable applications, and is not restricted to the application of the HL7 CCOW standard.

The system 100 includes a processor 102, a memory 104, a user interface 106, and a communication interface 108, each being connected over a communication path 110. The processor 102 further includes an input processor 112, a communication processor 114, an activity manager 116, an entitlement processor 118, and a display processor 120. The memory 104 further includes a first application 122, a second application 124, a managing application 126, and a browser application 128. The user interface 106 further includes a data input device 130 and a data output device 132.

The system 100 may be employed by any type of enterprise, organization, or department, such as, for example, providers of healthcare products and/or services responsible for servicing the health and/or welfare of people in its care. For example, the system 100 represents a hospital information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 and/or elements contained therein also may be implemented in a centralized or decentralized configuration. The system 100 may be implemented as a client-server, web-based, or stand-alone configuration. In the case of the client-server or web-based configurations, one or more of the first 122 and second application 124 may be accessed remotely over a communication network.

The communication path 110 (otherwise called network, bus, link, connection, channel, etc.) represents any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethemet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol. For example, CCOW is implemented with the Health Level Seven (HL7) protocol, in accordance with the HL7 standard.

The system 100, elements, and/or processes contained therein, as shown in FIGS. 1, 2, and 3, may be implemented in hardware, software, or a combination of both, and may include one or more processors, such as processor 102. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

The memory 104 represents any type of storage device. The memory 104 stores executable applications and associated data. The memory 104 represents one or more memory devices, located at one or more locations, depending on the particular implementation of the system 100.

The user interface 106 permits bi-directional exchange of data between the system 100 and a user of the system 100 or another electronic device.

The data input device 130 typically provides data to a processor in response to receiving input data either manually from a user or automatically from an electronic device, such as a computer. For manual input, the data input device is a keyboard and a mouse, but also may be a touch screen, or a microphone with a voice recognition application, for example. For automatic input from an electronic device, the data input device 130 is a data modem.

The data output device 132 typically provides data from a processor for use by a user or an electronic device, such as a computer. For output to a user, the data output device 132 is a display that generates one or more display images in response to receiving the display signals from the display processor 120, but also may be a speaker or a printer, for example. For electronic output to an electronic device, the data output device 132 is a data modem.

The display processor 120 or generator is a known element comprising electronic circuitry or software or a combination of both for generating display images or portions thereof. The display processor 120 may be implemented in the processor 102 and/or the user interface 106.

The first application 122, second application 124, managing application 126, and browser application 128 each represent executable applications. An executable application is typically stored in a memory, such as memory 104. An executable application comprises code or machine readable instruction for implementing predetermined functions including, for example, those of an operating system, a software application program, a healthcare information system, or other information processing system, for example, in response user command or input. An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters. A calling procedure is a procedure for enabling execution of another procedure in response to a received command or instruction. An object comprises a grouping of data and/or executable instructions or an executable procedure.

The first 122 and second 124 applications maintain a state with regard to user activity. Activity may also be caused by another device interacting with an application in addition to or instead of the user. User or device activity includes any interaction, such as data input, output, or exchange, with one or more applications (e.g., the first 122 and second 124 applications). An application may be in an active state or an inactive state.

An active state corresponds to a condition in which a user has been validated (i.e., when the system 100 permits or approves of a user session), and has accessed an application before a predetermined amount of time, representing an inactivity threshold, (otherwise called a timeout window) has expired. Intermittently received data, identifying activity, prevents an inactivity timeout of the first application 122. The application enters the active state when a user activity indicator is set to logic one (i.e., high state), and when there is activity from the user. The application stays in the active state until the predetermined amount of time, representing the inactivity threshold, has expired. User initiated activity comprises one or more of the following: (a) keyboard activity, (b) mouse activity, (c) other data input device 130 activity, and (d) another user initiated personal computer (PC) application operation activity.

An inactive state corresponds to a condition in which a user has been invalidated (i.e., when the system 100 prevents, cancels or terminates, etc. a user session), and that the predetermined amount of time, representing an inactivity threshold, has expired. The application enters the inactive state when a user activity indicator is set to logic zero (i.e., logic low or null state), and when there is no activity from the user. The application stays in the inactive state until the user completes a log on process.

An indication (e.g., a message) that the first application 122 is inactive includes one or more of the following: (a) a session identifier for identifying a particular user initiated session, (b) a universal resource locator (URL) to be contacted if an activity notification is not successful, and (c) an identification of a type of event preventing an activity notification from being successful.

The first 122 and second 124 applications represent multiple concurrently operating applications in a particular user initiated session or common context, such as in the HL7 CCOW standard.

In human-computer interaction, session management is the process of keeping track of a user's activity across sessions of interaction with the computer system 100. Typical session management tasks in a desktop environment might include keeping track of which applications are open and which documents each application has opened, so that the same state can be restored when the user logs out and logs in later. For a website, session management might involve requiring the user to re-login if the session has expired (i.e., a certain time limit has passed without user activity). Session management is particularly useful in a web browser where a user can save all open pages and settings and restore them at a later date. To help recover from a system or application crash, pages and settings can also be restored on next run.

The managing application 126 coordinates inactivity timeout thresholds among the multiple applications so that a user remains logged on the multiple applications, even though one of the multiple applications has reached its inactivity timeout threshold. The managing application 126 does this by exchanging data representing activity status indications between multiple concurrently operating applications (e.g., the first 122 and second 124 applications). The activity status indications are received from individual applications of the multiple concurrently operating applications, and indicate change of status of individual applications from active to inactive. The multiple concurrently operating applications are initiated by user commands via the user interface. The managing application 126 may be a separate application or be implemented as part of the second application 124. Alternatively, the first application 122 and the managing application 126 may reside in the same personal computer (PC).

The browser application 128 provides a user interface display permitting user entry of identification information and commands, and permitting user viewing of information for multiple Internet compatible applications. For example, the concurrently operating applications may be initiated by user commands via the browser application 128. The browser application 128 uses a uniform resource locator, URL, or Web address, as a standardized address name layout for resources (e.g., documents or images) on the Internet or elsewhere.

The activity manager 116, otherwise called an activity processor or a context manager, intermittently receives data identifying activity associated with the first application 122, and determines whether the first application 122 is active or inactive in response to a first application timeout window not being exceeded or being exceeded, respectively, because of insufficient activity associated with the first application 122. The activity manager 116 initiates logoff of the particular user initiated session in response to a determination that both the first 122 and second 124 applications are inactive. The activity manager 116 inhibits logoff of the particular user initiated session in response to a determination that one of the first 122 and second 124 applications are active.

The communication processor 114 coordinates the communications between the processor 102 and the memory 104 and/or the communication interface 108. For example, the communication processor 114 communicates to the managing application 126 an indication the first application 122 is inactive. The communication processor 114 receives from the managing application 126 an indication the second application 124 is active or inactive determined as a result of a second application timeout window not being exceeded or being exceeded, respectively, due to sufficient or insufficient activity, respectively, associated with the second application 124.

The input processor 112 receives an activity status indication from the first application identifying whether the first application 122 is active or inactive. The input processor 112 receives the activity status indication in data representing multiple different commands including an activity notification command, and a command involving one or more of the following: (a) determining a user operation session identifier from the managing application 126, and (b) sending a universal resource locator (URL) to the managing application 126. The activity status indication includes one or more of the following: (a) an identification of a particular user initiated session, (b) a URL to be contacted if said activity notification is not successful, and (c) an identification of a type of event preventing the activity notification from being successful.

The entitlement processor 118 enables user access to the first application 122 in response to validation of user identification information, such as, for example, identification (ID), password, biometrics, user name, etc. Validation and invalidation includes matching and not matching, respectively, the user's entered identification information to identification information stored by the system 100. The communication processor 114 also communicates with the browser application 128 providing a user interface display permitting user entry of identification information for validation by the entitlement processor 118.

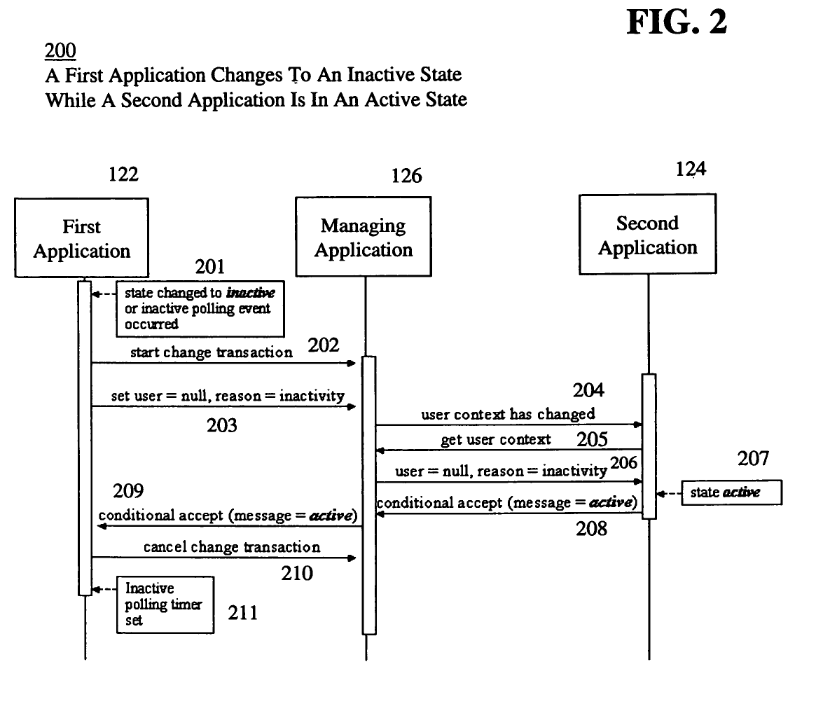

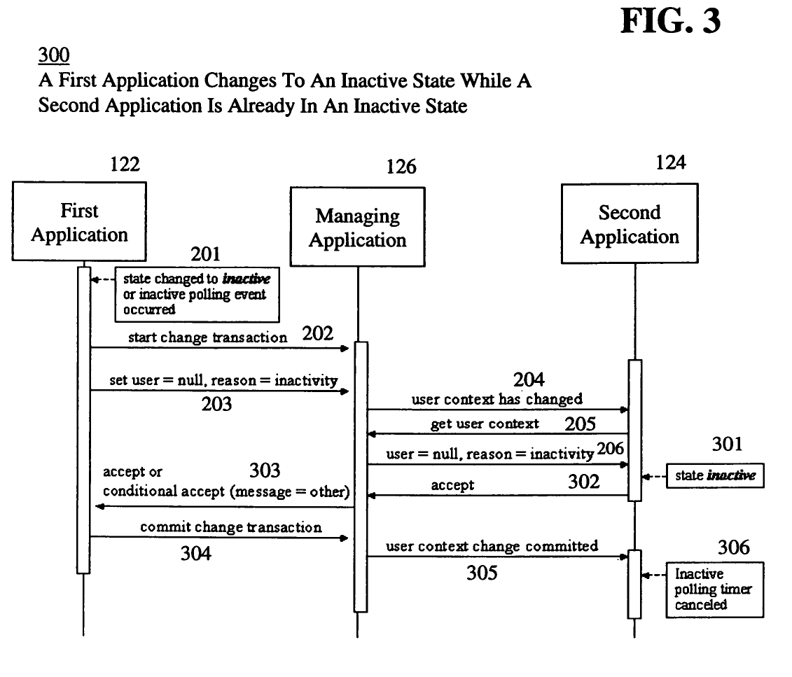

FIGS. 2 and 3 illustrate interactions to synchronize conditions of user inactivity timeout between at least two CCOW compliant applications.

FIG. 2 illustrates a process flow diagram 200, for the system 100, as shown in FIG. 1, showing the first application 122 changing to an inactive state while the second application 124 is in an active state.

At process 201, the first application 122 changes to an inactive state due to the user not interacting with the first application 122 within the inactivity threshold of the first application 122, or due to an inactive polling event occurring.

At process 201, while in the inactive state, the first application 122 periodically attempts to nullify the user (i.e., close the session for the concurrently operating applications) with reason code set to indicate inactivity by using the polling event. Polling is performed to ensure that the user activity indicator eventually is nullified in the event that the second application 124 leaves the context or becomes unresponsive while in the active state. The first application 122 stops polling when either the user activity indicator is set to null, or when the first application 122 leaves the inactive state (e.g., changes to the active state because of user interaction).

At process 202, the first application 122 communicates a context change transaction to the managing application 126. In particular, at activity 202, the context change transaction represents the first application 122 changing from an active state to an inactive state. The managing application 126 advantageously coordinates inactivity timeout thresholds among the first 122 and second 124 applications so that a user remains logged on the first 122 and second 124 applications, even though one of the first 122 and the second 124 applications has reached its inactivity threshold or an inactive polling event occurred.

At process 203, the first application 122 sets the user activity indicator identifier to null, to invalidate the current user, and sets a reason code to “inactivity,” to indicate the reason for the null setting as inactivity by the user. The first application 122 communicates the settings of the user activity indicator and the reason code to the managing application 126.

At process 203, the first application 122 intends to change from the active state to the inactive state, and notifies the managing application 126 of the intention, but the first application 122 waits for a response from the managing application 126 before finalizing the transaction of nullifying the user from the session. If the managing application 126 responds that the other applications associated with the session are also inactive, then the first application 122 commits to change transaction and nullifies the user (see steps 204-206 in FIG. 2, and steps 301-306 in FIG. 3). Otherwise, if the managing application 126 responds that at least one other application associated with the session is still active, the first application 122 cancels the change transaction and returns to the active state (see steps 204-211 in FIG. 2).

At process 204, the managing application 126 informs the second application 122 of an intention of the first application 122 to change context to nullify the user activity indicator.

At process 205, the second application 122 requests the reason code from the managing application 126 to determine the reason that the first application 122 has nullified the user activity indicator.

At process 206, the managing application 126 replies to the second application 122 that the user activity indicator was set to null, to invalidate the current user, and that the reason code was set to “inactivity.” The reason code indicates that the first application 122 intends to nullify the user activity indicator because the first application 122 has reached its inactivity threshold.

At process 207, the second application 122 determines that the second application 122 is presently in the active state because the second application 122 has not yet reached its inactivity threshold. In combination, activities 204-207 permit the managing application 126 to interrogate the second application 124 to determine if the second application timeout window is exceeded in response to the indication that the first application 122 is inactive.

At process 208, the second application 122 returns to the managing application 126 a conditional accept response with a response message of “active” indicating that the second application 122 is in an active state.

At process 209, the managing application 126 sends the conditional accept response with the response message of “active” to the first application 122. The first application 122 receives the conditional accept response with the response message of “active” from the managing application 126, and determines that at least one application (e.g., the second application 122) responded with the “active” message, indicating that at least one application has not yet reached its inactivity threshold.

At process 210, the first application 122 cancels (i.e., changes back or rolls back) the user activity indicator change made in process 203, and communicates an intention to context change transaction to the managing application 126. In particular, the first application 122 sets the user activity indicator to logic one (i.e., high), to validate the current user, and sets the reason code to “activity,” to indicate the reason for the logic one setting as activity by the user. The first application 122 communicates the changed settings of the user activity indicator and the reason code to the managing application 126.

At process 211, the first application 122 sets a timer, such as a polling timer. When or if the polling timer expires, the first application 122 repeats the user context change sequence, by returning to process 201.

FIG. 3 illustrates a process flow diagram 300, for the system 100, as shown in FIG. 1, showing the first application 122 changing from an active state to an inactive state while the second application 124 is already in an inactive state.

Activities 201-206 are the same as described with reference to FIG. 2.

At process 301, the second application 124 determines that the second application 124 is presently in the inactive state because the second application 124 has reached its inactivity threshold.

At process 302, the second application 124 returns to the managing application 126 an accept response indicating that the second application 124 is in the inactive state because the user inactivity threshold has been reached.

At process 303, the managing application 126 sends an accept or a conditional accept response with the response message of “other” to the first application 122. The first application 122 receives the accept or conditional accept response with the response message of “other” from the managing application 126, and determines that no other application (e.g., the second application 124) responded with the “active” message, indicating that each of the other associated applications have reached their inactivity threshold.

At process 304, the first application 122 commits (i.e., verifies, approves, etc.) the user activity indicator change made in process 203, and communicates to the managing application 126 an intention to commit to the context change transaction from an active state to an inactive state. At process 304, the first application 122 initiates log off of the particular user initiated session in response to a determination both of the first 122 and second 124 applications are inactive.

At process 305, the managing application 126 communicates that the first application 122 committed to the context change transaction from the active state to the inactive state. Hence, the managing application initiates log off the particular user initiated session in response to a determination that both the first 122 and second 124 applications are inactive.

At process 306, the second application 122 cancels a timer, such as an inactive polling timer.

The system 100, via the managing application 126, effectively logs the user off the participating applications (e.g., first 122 and second 124 applications). The first 122 and second 124 applications are in an inactive state, and no user activity indicator is set. If or when the user activity indicator is set again due to user activity in one of the first 122 and second 124 applications, both applications would change to the active state, and begin monitoring user activity using the inactivity threshold.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A system for use in a first application concurrently operating together with a second application, comprising:
an activity manager for intermittently receiving data identifying activity associated with said first application and determining said first application is inactive in response to a first application timeout window being exceeded because of insufficient activity; and
a communication processor for communicating to a managing application an indication said first application is inactive and for receiving from said managing application an indication said second application is inactive determined as a result of a second application timeout window being exceeded due to insufficient activity associated with said second application.

2. A system according to claim 1, wherein
said first and second applications are concurrently operating applications of a particular user initiated session, and
said activity manager initiates logoff of said particular user initiated session in response to a determination that both said first and second applications are inactive.

3. A system according to claim 1, wherein
said first and second applications are concurrently operating applications of a particular user initiated session, and
said communication processor receives from said managing application an indication said second application is active determined as a result of sufficient activity associated with said second application preventing said second application timeout window being exceeded and
said activity manager inhibits logoff of said particular user initiated session in response to a determination said second application is active.

4. A system according to claim 1, wherein
said intermittently received data identifying activity prevents an inactivity timeout of said first application, and
said first and second applications are concurrently operating applications of a particular user initiated session.

5. A system according to claim 1, wherein
said managing application comprises said second application.

6. A system according to claim 1, wherein
said managing application interrogates said second application to determine if said second application timeout window is exceeded in response to said indication that said first application is inactive.

7. A system according to claim 1, wherein
said user action comprises at least one of the following: (a) keyboard activity, (b) mouse activity, (c) other data input device activity, and (d) another user initiated personal computer (PC) application operation activity.

8. A system according to claim 1, wherein
said first application and said managing application reside in the same personal computer (PC), and
said indication said first application is inactive includes one or more of the following: (a) a session identifier for identifying a particular user initiated session, (b) a universal resource locator (URL) to be contacted if said activity notification is not successful, and (c) an identification of a type of event preventing said activity notification from being successful.

9. A system according to claim 1, including
an entitlement processor enabling user access to said first application in response to validation of user identification information, and
said communication processor communicates with a browser application providing a user interface display permitting user entry of identification information for validation by said entitlement processor.

10. A system for use by a managing application supporting concurrent operation of a first application together with a second application, comprising:
an input processor for receiving an activity status indication from said first application identifying whether said first application is inactive; and
a communication processor for, in response to said received activity status indication from said first application,
communicating to said second application, data indicating a change of status of said first application from active to inactive;
receiving from said second application data indicating said second application activity status; and
communicating data indicating said second application activity status to said first application.

11. A system according to claim 10, wherein
said first and second applications are concurrently operating applications of a particular user initiated session.

12. A system according to claim 11, wherein
said first application initiates logoff of said particular user initiated session in response to a determination both said first and second applications are inactive.

13. A system according to claim 11, wherein
said managing application initiates logoff of said particular user initiated session in response to a determination that both said first and second applications are inactive.

14. A system according to claim 10, wherein
said input processor receives said activity status indication in data representing a plurality of different commands including an activity notification command, and a command involving at least one of the following: (a) determining a user operation session identifier from said managing application and (b) sending a universal resource locator (URL) to said managing application.

15. A system according to claim 10, wherein
said activity status indication includes one or more of the following: (a) an identification of a particular user initiated session, (b) a URL to be contacted if said activity notification is not successful, and (c) an identification of a type of event preventing said activity notification from being successful.

16. A system supporting concurrent operation of a plurality of Internet compatible applications, comprising:
a browser application providing a user interface display permitting user entry of identification information and commands for a plurality of Internet compatible applications; and
a managing application for exchanging data representing activity status indications between a plurality of concurrently operating applications, said activity status indications being received from individual applications of said plurality of concurrently operating applications and indicating change of status of individual applications from active to inactive, said plurality of concurrently operating applications being initiated by user commands via said browser user interface.

17. A method for use in a first application concurrently operating together with a second network compatible application, comprising the activities of:
intermittently receiving data identifying activity associated with said first application and determining said first application is inactive in response to a first application timeout window being exceeded because of insufficient activity;
communicating to a managing application an indication said first application is inactive; and
receiving from said managing application an indication said second application is inactive determined because of a second application timeout window being exceeded due to insufficient activity associated with said second application.
